(19) United States
(12) Patent Application Publication
(10) Pub. No.: US 2012/0048131 A1
(43) Pub. Date: Mar. 1, 2012

(54) BRAILLE SLEEVE

(75) Inventors: WOLFGANG DIEHR, GREVENBROICH (DE); MARTIN MERTENS, SCHRIESHEIM (DE); FRANK SCHMID, KREFELD (DE)

(73) Assignee: HEIDELBERGER DRUCKMASCHINEN AG, HEIDELBERG (DE)

(21) Appl. No.: 13/222,078

(22) Filed: Aug. 31, 2011

(30) Foreign Application Priority Data
Aug. 31, 2010 (DE) 10 2010 036 011.2

(51) Int. Cl. B44B 5/00

(52) U.S. Cl. 101/3.1

(57) ABSTRACT

A tool is provided for a rotary embossing device for embossing flat, sheet-shaped material. The device includes two rotating embossing tools in the form of a male tool and a female tool for creating an embossing. At least the male tool has a roller body to which a seamless annular tool sleeve is attached. The tool sleeve of the male tool has raised embossing dots on its outer circumferential surface. These dots interact with corresponding recesses in the outer circumferential surface of the female tool.

### CROSS-REFERENCE TO RELATED APPLICATION

This application claims the priority, under 35 U.S.C. §119, of German application DE 10 2010 036 011.2, filed Aug. 31, 2010; the prior application is herewith incorporated by reference in its entirety.

### BACKGROUND OF THE INVENTION

### Field of the Invention

The invention relates to a tool for a rotary embossing device for embossing flat, sheet-shaped material. The tool has two rotating embossing tools including a male embossing tool and a female embossing tool for creating the embossing. The invention further relates to a folder gluer having a Braille embossing device.

Folding boxes are packaging materials made of cardboard or corrugated board or, to a more limited extent, of plastics. At one or more locations, glue is applied to the material during the folding operation as required for the individual construction of the folding box. As a rule, a folding box is made out of a blank that has been cut out in a diecutting machine. At least one edge of the blank must be glued. The folded boxes exit the folder gluer in a flat state. The folding box is then erected and filled either in a machine or in a manual process.

In addition to the folding operations required to manufacture the folding boxes, additional crease lines are formed or prefolded in the folder gluer in preparation of subsequent production steps. These crease lines facilitate the erection and filling of the box.

If the folding boxes are intended as packaging for pharmaceutical products, the law requires the name of the product or medicine to be applied to the folding box in Braille letters for the blind (for instance in an embossing process). Moreover, Braille letters or other embossing need to be applied to many blister packs or blister cards.

In the prior art, Braille letters may be embossed during the diecutting operation in the diecutting machine when the blanks are being produced. However, this is a laborious process because one sheet contains a number of blanks and for each blank a pair of tools consisting of a female and a male tool needs to be provided. Alternatively, the Braille letters may be created in a rotary embossing device that has two rotating embossing tools and may for instance be part of a folder gluer. Such rotary embossing tools are known to have a common drive for both rotary tools. To create the embossing in the correct location on the blank or blister pack, the rotary tools need to be synchronized relative to the folding box blank. In particular if the embossing to be made in the folding box blank are Braille characters, the synchronization must be made with great accuracy. Due to the inertia of the female and male embossing tools and the rotary drive the required degree of synchronization accuracy is difficult or even impossible to achieve. Another disadvantage is that to improve synchronization, rotary embossing devices are frequently operated in a start/stop mode, i.e. they are stopped and subsequently reaccelerated for synchronization purposes. This aspect has a detrimental effect on the productivity of the rotary embossing device. Another aspect that limits productivity is that the rotary embossing tool cannot be adapted to the size of the product to be processed.

Such a rotary embossing device for a folder gluer is known from European patent application No. EP 20 36 712 A2.

The known Braille embossing devices generally consist of an upper rotary tool known as the male Braille tool, and a lower rotary embossing tool, known as the female Braille tool. On its embossing side, the male Braille tool has a predetermined number of raised Braille embossing dots. The female Braille tool generally has the maximum number of Braille dot recesses and can thus be universally used. The number of recesses depends on whether the Braille letters are written in the common six-dot notation or in the eight-dot notation.

The production of packaging for pharmaceuticals in particular requires a multitude of different Braille imprints. For each new job to be produced, the male Braille tool needs to be modified. Thus a large number of male Braille tools needs to be stored in a tool storeroom.

To reduce storage requirements, German Utility Model No. DE 20 2008 017 133 U1 proposes to keep the roller body unmodified and only to change the actual tool. The tool is held against the circumferential surface of the roller body by magnets.

Another known Braille embossing method is to provide sheet metal strips as the male tool and to screw the sheet metal strips onto the male tool cylinder. The attachment holes that are required to fix the sheet metal strip to the cylinder reduce the maximum circumferential surface that can be used for embossing such as Braille letters. In addition, the strips are difficult to mount. If a strip is mounted in the wrong way, it may assume a helical shape, which is detrimental to the quality of the imprint. Moreover, the embossing tool on the strip of sheet metal is created when the strip is in a flattened position. Yet when it is used in the embossing operation, the strip is wrapped around a circumference of a cylinder and forms an arcuate segment. Errors or distortions in the imprint may be the result. Moreover, there may be a gap between the strip of sheet metal and the male embossing tool cylinder. Such a gap may cause the strip to move up and down and may thus cause premature wear of the female tool. Due to the strict accuracy requirements, this solution is hardly suited for embossing Braille characters. At the high production speeds for instance in a folder gluer (of up to 200,000 boxes/h), the system may get out of balance because the embossing tool only covers part of the circumferential surface. Balancing measures are necessary to counteract this phenomenon.

German Utility Model No. DE 20 2006 005 299 U1 discloses an embossing cylinder or an embossing sleeve arranged on a carrier core for the creation of an embossed structure on a thermoplastic material such as a transparent decorative film. The embossing cylinder or embossing sleeve has individual recesses in the total outer cylinder surface. The material to be embossed is guided through a nip between the embossing cylinder and a smooth counter pressure roller. This device is not suited for creating Braille characters.

### SUMMARY OF THE INVENTION

It is accordingly an object of the invention to provide a Braille sleeve which overcomes the above-mentioned disadvantages of the prior art methods and devices of this general type, and uses a rotary device for embossing purposes, in particular for embossing Braille characters into flat sheet-shaped material, where the male embossing tool is easily exchangeable.

In accordance with a preferred embodiment of the invention, the tool for a rotary embossing device for embossing flat, sheet-shaped material includes two rotating embossing tools in the form of a male and a female embossing tool. At least the male embossing tool contains a roller body and a seamless, continuous tool sleeve attached thereto. The sleeve has raised embossing dots on its outer circumferential surface. The outer circumferential surface of the female embossing tool has recesses that correspond to the raised embossing dots. In accordance with an advantageous embodiment, the embossing tools are suited for embossing Braille characters. In this case, the female tool may be a universal female Braille tool that has the maximum possible number of Braille recesses per Braille letter. An advantage of these embodiments is that the entire circumferential surface can be used as an embossing surface. Compared to the known strips of sheet metal of the prior art the length of the area that can be used for embossing purposes is increased. In addition, the balancing and distortion problems of the known metal strip solutions are eliminated.

In accordance with further preferred embodiments, the tool sleeve is made of aluminum, steel, magnesium, brass, bronze, titanium, or plastic. Thus the respective advantages of these materials such as hardness, durability, resistance to wear, or low manufacturing cost or rather usability in low-cost manufacturing processes can be exploited. The embossing dots and recesses, respectively, may thus be created in a cost-efficient way in a cupping process from the back or by building up (build-up welding) or by removal of material by milling, etching, or eroding on the outer side. Materials with a suitable surface coating such as a Hard Coat may also be used.

In accordance with a particularly preferred further embodiment the tool sleeve is attached to the roller body by a self-locking cone or a precise fit and/or a pin or a screw in the radial direction or by tension rods. Other attachment options such as pneumatic or hydraulic or mechanical or electrical radial tensioning elements are likewise possible. These attachment means are of simple construction and thus allow a quick exchange of the tool sleeve, thus considerably reducing set-up times.

In accordance with further advantageous embodiments the tool body has a stop to ensure correct positioning of the tool sleeve in the axial direction. Alternatively, the tool sleeve may have a stop that interacts with a groove in the outer region of the roller body. Thus easy and reliable axial positioning of the tool sleeve on the roller body is possible.

In accordance with a particularly advantageous embodiment the stop provided on the tool sleeve and the groove provided in the outer region of the roller body extend at an angle.

In accordance with a further advantageous embodiment the tool sleeve forms the rotor of an electric motor. In addition, the collar of the tool sleeve may be embodied to act as an incremental encoder for the motor.

The tool may advantageously be used in a Braille embossing device in a folder gluer.

Other features which are considered as characteristic for the invention are set forth in the appended claims.

Although the invention is illustrated and described herein as embodied in a Braille sleeve, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of an embossing device having a tool according to the invention;

FIG. 2 is an illustration showing an unwrapped and flattened circumferential surface of a male tool sleeve in accordance with the invention;

FIG. 3 is an illustration showing the unwrapped and flattened circumferential surface of a universal female tool sleeve in accordance with the invention;

FIGS. 4A-4E are diagrammatic, sectional views of different attachment means on the tool sleeve and a roller body;

FIG. 5 is a diagrammatic representation of a tool sleeve as a rotor of an electric motor;

FIG. 6 is a diagrammatic illustration without an embossing roller;

FIG. 7 is an illustration showing an alternative tool sleeve;

FIG. 8A is a diagrammatic, perspective view of a Braille embossing module for a folder gluer; and

FIG. 8B is a diagrammatic, top plan view of the Braille embossing module for the folder gluer.

### DETAILED DESCRIPTION OF THE INVENTION

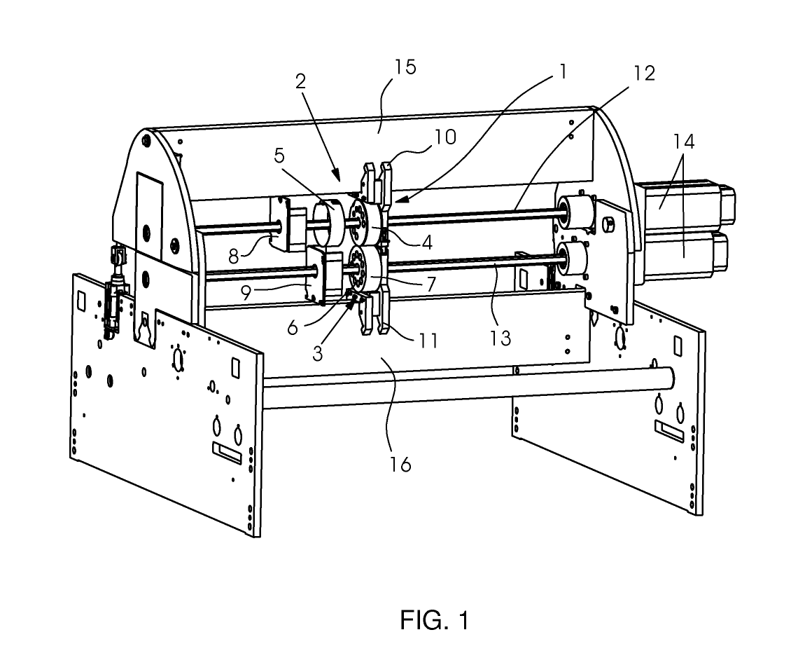

Referring now to the figures of the drawing in detail and first, particularly, to FIG. 1 thereof, there is shown an embossing device having a tool 1 in a partly disassembled condition. The tool 1 is formed of an upper tool configured as a male embossing tool 2 and a lower tool configured as a female embossing tool 3. The male tool 2 has a roller body 4 to which a seamless, continuous tool sleeve 5 is attached. The outer circumferential surface of the sleeve 5 has raised embossing dots 24, which are not shown in FIG. 1 for reasons of clarity. The female tool 3 likewise includes a roller body 6, which has corresponding recesses 25 on its outer circumferential surface. Again, the recesses 25 are not shown in FIG. 1 for reasons of clarity. The recesses 25 may be introduced directly into the outer circumferential surface 7 of the roller body 6 of the female tool 3 or, as it is the case with the male tool, they may be formed in a (non-illustrated) tool sleeve that is attached to the roller body 6 of the female tool 3. Both the male tool 2 and the female tool 3 are protected against contact by protective boxes 8, 9. The male tool 2 is supported on a non-illustrated flange and is driven by a drive shaft 12. Moreover, it is laterally guided by an upper tool-guiding element 10 that is supported by a crossbar 15. The female tool 3 is supported on a non-illustrated flange and is driven by a lower drive shaft 13. Moreover, it is guided in the lateral direction by a lower tool-guiding element 11 that is supported by a lower crossbar 16. The drive shafts 12, 13 are driven by servomotors 14.

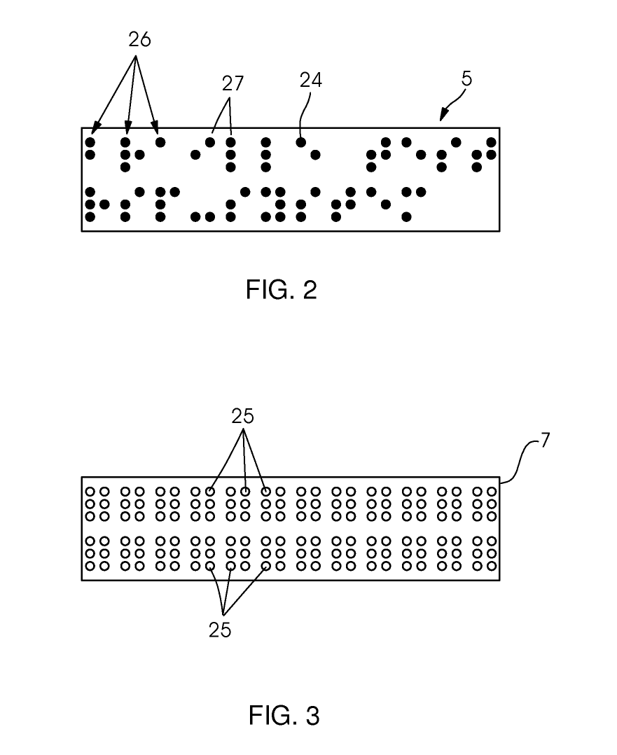

FIG. 2 illustrates an unwrapped, flat outer circumferential surface of a tool sleeve of a male tool 2 configured in accordance with the invention. The Braille characters 26 shown in this embodiment are based on the six-dot notation, which has a maximum of six raised dots 24 per character, arranged in two adjacent columns of dots 27.

FIG. 3 illustrates an unwrapped, flat outer circumferential surface 7 of the roller body 6 of a female tool 3. In the illustrated exemplary embodiment, the female tool 3 is embodied as a universal female tool which includes the maximum of six dots per character as negative recessions 25. Thus the female tool can be used for all possible male tools of the six-dot notation.

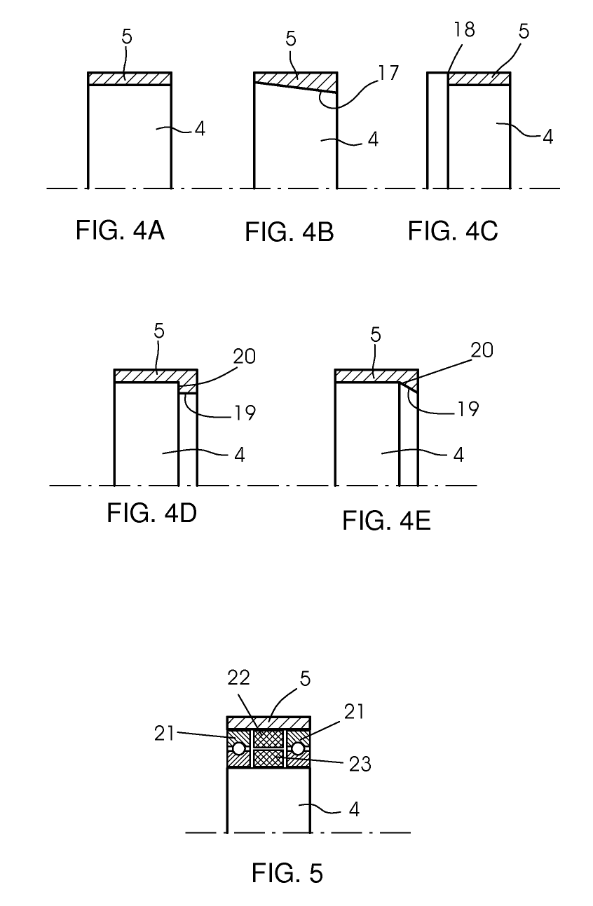

FIGS. 4A-4C illustrate different ways of fixing the tool sleeve 5 to the roller bodies 4, 6. When the universal female tool is used on the outer circumferential surface 7 of the female tool 3, only the male tool 2 needs to be exchanged and fixed to the roller body 4. Thus only this version is shown.

FIG. 4A illustrates an option to fix the tool sleeve 5 to the roller body by a precision fit or form-locking connection. FIG. 4B illustrates a self-locking cone 17 as a measure of fixing the tool sleeve 5 to the roller body 4. In FIG. 4C, the outer surface of the roller body 4 has a stop 18 for the axial alignment of the tool sleeve 5. In FIG. 4D, the roller body 4 has a groove 19 formed in its outer surface to cooperate with a stop 20 formed on the tool sleeve 5, thus presenting an alternative way of ensuring axial alignment of the tool sleeve 5. Another alternative is shown in FIG. 4E. In this embodiment the groove 19 and the stop 20 are arranged at an angle. Further non-illustrated attachment options are conceivable such as a radial attachment by a pin or screw or an attachment by of clamping jaws. The various attachment measures can of course be used in combination with each other.

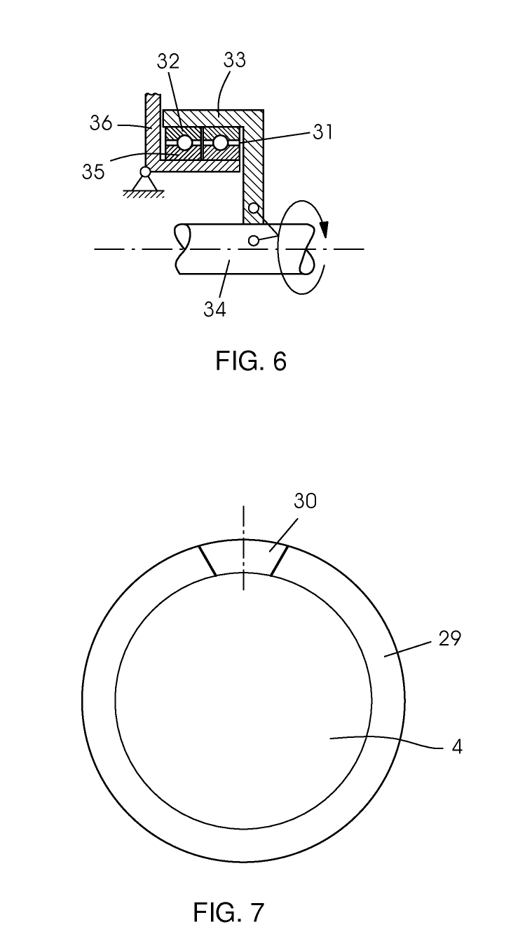

FIGS. 5 and 6 illustrate alternative embodiments. In the embodiment shown in FIG. 5, the male tool sleeve 5 is directly embodied as a rotor 22 of a motor. The collar of the tool sleeve may additionally be configured to act as an incremental encoder for the motor.

In the embodiment shown in FIG. 6, the roller body 4 is dispensed with. The tool sleeve 33 is supported directly on an outer ring 32 of the roller bearing 31. The rotary movement is directly transmitted to the tool sleeve 33 by a polygonal shaft 34. Thus the entire mass of the roller body 4 is eliminated. The inner ring 35 of the roller bearing 31 and the tool support 35 are supported to be fixed against rotation.

FIG. 7 illustrates a further alternative embodiment of the tool sleeve configured as a slit tool sleeve 29. The tool sleeve 29 is attached to the tool body 4 by a filler element 30 and a non-illustrated fixing device such as a screw. Due to the fact that the slit in the tool sleeve 29 and the side walls of the filler element 30 are inclined in a complementary way, the filler element 30 fixes the tool sleeve 29 on the roller body 4. In addition, the sleeve 29 is clamped to the tool body 4 due to the aforementioned conical design of the roller body 4. The sleeve 29 is positioned on the roller body in the circumferential direction by the fixing device described above. This embodiment provides a particularly easy way of exchanging the tool sleeve.

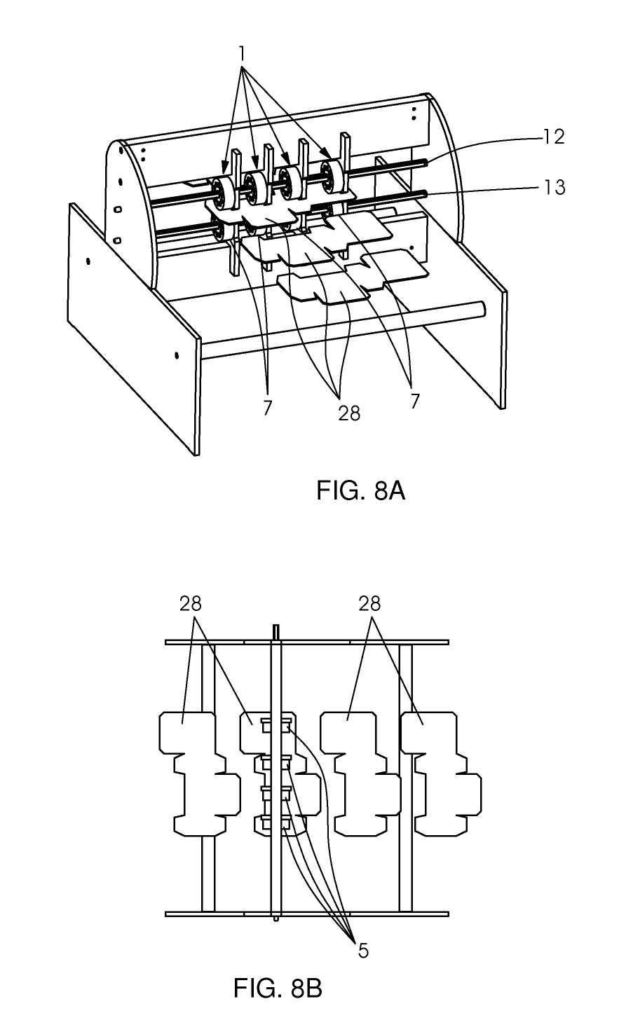

FIGS. 8A and 8B illustrate the application of the tools of the invention in a rotary embossing device for a folder gluer, for example. In the illustrated embodiment, four tools 1 are arranged adjacent to each other to carry out embossing operations on box blanks 28.

1. A tool configuration for a rotary embossing device for embossing flat, sheet-shaped material, the tool comprising:
two rotating embossing tools including a male embossing tool and a female embossing tool for creating an embossing, at least said male embossing tool having a roller body and a seamless, continuous tool sleeve with raised embossing dots on an outer circumferential surface, said female embossing tool having recesses formed therein, said raised embossing dots interacting with corresponding ones of said recesses formed in said female embossing tool.

2. The tool configuration according to claim 1, wherein said male and female embossing tools are suited for embossing Braille characters.

3. The tool configuration according to claim 1, wherein said female embossing tool is a universal female Braille tool having a maximum possible number of Braille recesses per Braille character.

4. The tool configuration according to claim 1, wherein one of said tool sleeve or said outer circumferential surface of said female embossing tool is made from a material selected from the group consisting of aluminum, steel, magnesium, titanium, brass, bronze and plastic.

5. The tool configuration according to claim 1, wherein said tool sleeve has a surface coating.

6. The tool configuration according to claim 1, wherein said male embossing tool has an attaching element selected from the group consisting of a self-locking cone, a form-fitting connection, a screw, a pin in a radial direction, clamping jaws, pneumatic radial clamping elements, hydraulic radial clamping elements, mechanical radial clamping elements and electrical radial clamping elements, said tool sleeve is attached to said roller body by said attaching element.

7. The tool configuration according to claim 1, wherein said roller body has a stop for positioning said tool sleeve in an axial direction.

8. The tool configuration according to claim 1, wherein said tool sleeve has a stop for an axial positioning of said tool sleeve on said roller body, said roller body having an outer region with a groove formed therein and said stop interacting with said groove.

9. The tool configuration according to claim 8, wherein said stop of said tool sleeve and said groove formed in said outer region of said roller body extend at an angle.

10. The tool configuration according to claim 1, wherein:
said roller body has an roller body element being one of a tongue, a groove formed in said roller body, a bore formed in said roller body, or a threading; and
said tool sleeve has one of a groove, tongue, bore, or threading interacting with said roller body element for positioning said tool sleeve in a circumferential direction in a form-locking way.

11. The tool configuration according to claim 12, wherein said tool sleeve has a fastener selected from the group consisting of a cylinder pin, a taper pin and a screw, for securing said tool sleeve to said roller body.

12. The tool configuration according to claim 1, wherein said tool sleeve forms a rotor of an electric motor.

13. The tool configuration according to claim 5, wherein said surface coating is a Hard Coat.

14. A tool configuration for a rotary embossing device for embossing flat, sheet-shaped material, the tool comprising:
two rotating embossing tools including a male embossing tool and a female embossing tool for creating an embossing, said male embossing tool having a roller body, a fixing element and a slit tool sleeve with raised embossing dots on an outer circumferential surface thereof, said female embossing tool having recesses formed therein, said raised embossing dots interacting with corresponding ones of said recesses formed in said female embossing tool, said slit tool sleeve being attached to said roller body by said fixing element.

15. The tool configuration according to claim 14, wherein said fixing element is a filler element.

16. The tool configuration according to claim 14, wherein said male and female embossing tools are suited for embossing Braille characters.

17. The tool configuration according to claim 14, wherein said female embossing tool is a universal female Braille tool having a maximum possible number of Braille recesses per Braille character.

18. A tool configuration for a rotary embossing device for embossing flat, sheet-shaped material, the tool comprising:
two rotating embossing tools including a male tool and a female tool for creating an embossing, said male tool formed by a shaft, a roller bearing having an outer ring, and a tool sleeve directly supported on said outer ring of said roller bearing, said tool sleeve being directly driven by said shaft.

19. The tool configuration according to claim 18, wherein said shaft is a polygonal shaft.

20. A Braille embossing device, comprising:
a tool configuration for a rotary embossing device for embossing flat, sheet-shaped material, said tool configuration containing two rotating embossing tools including a male embossing tool and a female embossing tool for creating an embossing, at least said male embossing tool having a roller body and a seamless, continuous tool sleeve with raised embossing dots on an outer circumferential surface, said female embossing tool having recesses formed therein, said raised embossing dots interacting with corresponding ones of said recesses formed in said female embossing tool.

21. A Braille embossing device, comprising:
a tool configuration for a rotary embossing device for embossing flat, sheet-shaped material, said tool configuration containing two rotating embossing tools including a male embossing tool and a female embossing tool for creating an embossing, said male embossing tool having a roller body, a fixing element and a slit tool sleeve with raised embossing dots on an outer circumferential surface, said female embossing tool having recesses formed therein, said raised embossing dots interacting with corresponding ones of said recesses formed in said female embossing tool, said slit tool sleeve being attached to said roller body by said fixing element.

22. A folder gluer, comprising:
a Braille embossing device containing a tool configuration for a rotary embossing device for embossing flat, sheet-shaped material, said tool configuration containing two rotating embossing tools including a male embossing tool and a female embossing tool for creating an embossing, at least said male embossing tool having a roller body and a seamless, continuous tool sleeve with raised embossing dots on an outer circumferential surface, said female embossing tool having recesses formed therein, said raised embossing dots interacting with corresponding ones of said recesses formed in said female embossing tool.

23. A folder gluer, comprising:
a Braille embossing device containing a tool configuration for a rotary embossing device for embossing flat, sheet-shaped material, said tool configuration containing two rotating embossing tools including a male embossing tool and a female embossing tool for creating an embossing, said male embossing tool having a roller body, a fixing element and a slit tool sleeve with raised embossing dots on an outer circumferential surface, said female embossing tool having recesses formed therein, said raised embossing dots interacting with corresponding ones of said recesses formed in said female embossing tool, said slit tool sleeve being attached to said roller body by said fixing element.
